(19) United States
(12) Patent Application Publication
(10) Pub. No.: US 2015/0012240 A1
(43) Pub. Date: Jan. 8, 2015

(54) MOTION ANALYSIS DEVICE

(71) Applicant: SEIKO EPSON CORPORATION, Tokyo (JP)

(72) Inventor: Masafumi SATO, Hara-mura (JP)

(21) Appl. No.: 14/309,597

(22) Filed: Jun. 19, 2014

(30) Foreign Application Priority Data
Jul. 5, 2013 (JP) 2013-141720

(51) Int. Cl. G01P 15/08

(52) U.S. Cl. CPC G01P 15/0888
USPC 702/145

(57) ABSTRACT

An inertial sensor is attached to a sporting gear held by the hand (for example, a golf club). A static state determination unit determines a static state of at least one of the sporting gear and a subject, using an output from the inertial sensor. A notification signal generation unit outputs a static state notification signal according to the static state. The static state notification signal can induce a certain physical change perceived by the subject with the five senses. In response to the physical change, the subject can start a swing movement.

### BACKGROUND

1. Technical Field

The present invention relates to a motion analysis device.

2. Related Art

For example, a golf swing analysis as a specific example of a motion analysis device is generally known. A three-dimensional acceleration sensor is attached to a subject. The subject's golf swing is analyzed, based on an output from the three-dimensional acceleration sensor. See, for example, JP-A-2011-210 and JP-A-2000-148351.

A golf swing starts with the address, goes through the backswing, downswing and impact, then goes on to the follow-through, and reaches the finish. It is desirable that analysis of a golf swing should start at the address. In JP-A-2011-210, the golf swing analysis device is operated by a measurer. The measurer can confirm the address posture of the subject and start measuring the subject's swing. In such a golf swing analysis device, measurement of a swing cannot be started at proper timing in the absence of the measurer. It is desirable that measurement of a swing securely starts at the address even when the subject is by himself or herself.

### SUMMARY

An advantage of some aspect of the invention is to provide a motion analysis device which is capable of securely starting measurement of a swing at proper timing even when the subject is by himself or herself.

(1) An aspect of the invention relates to a motion analysis device including a calculation unit which determines a static state of at least one of a sporting gear and a subject, using an output from an inertial sensor, and outputs a static state notification signal according to the static state.

At the time of a swing, the sporting gear is gripped by the hands and thus swung. When swung, the sporting gear changes its posture along the time axis. The inertial sensor outputs a detection signal according to the posture of the sporting gear. The trajectory of the sporting gear in the swing can be specified according to the detection signal. The movement of subject can be analyzed, based on the trajectory of the sporting gear.

A swing starts in the static state of the sporting gear. The calculation unit grasps the static state of at least one of the sporting gear and the subject. The grasping of the static state is reported by a static state notification signal. The static state notification signal can induce a certain physical change that can be perceived by the subject with his or her five senses. In response to this physical change, the subject can start a swing movement. Thus, the calculation unit can securely follow the movement of the sporting gear over the entire swing. The motion analysis device can securely start measurement at proper timing even when the subject is by himself or herself. Redundant analysis can be avoided before a swing is started.

(2) When determining the static state, the calculation unit may determine whether the output from the inertial sensor falls within a first range or not. If the static state is secured at least with one of the sporting gear and the subject, the output from the inertial sensor falls within the first range. The static state is thus grasped. The static state notification signal is outputted in response to the grasping.

(3) When determining the static state, the calculation unit may determine whether an inclination of a line segment in a direction in which a shaft portion of the sporting gear extends falls within a second range or not, using the output from the inertial sensor. As the inclination of the shaft portion is thus specified, a static state corresponding to the start of measurement and a static state not corresponding to the start of measurement can be clearly distinguished. As a result, measurement can be prevented from being started in the static state not corresponding to the start of measurement. Proper timing can be securely specified.

(4) The output from the inertial sensor may include an output from an acceleration sensor. The motion analysis device may calculate the inclination of the line segment in the direction in which the shaft portion of the sporting gear extends with respect to a direction of gravity, using the output from the acceleration sensor. The inclination of the shaft portion is thus specified.

(5) The calculation unit may output a non-achievement notification signal if the static state is not detected within a first period. The non-achievement of the static state is reported by the non-achievement notification signal. The non-achievement notification signal can induce a certain physical change that can be perceived by the subject with his or her five senses. The subject is prompted to establish the static state in response to this physical change. Thus, the subject can securely establish the static state.

(6) The motion analysis device may include a start instruction input unit which outputs a trigger signal to start measurement with the inertial sensor. If the static state is not detected within the first period after the trigger signal is outputted from the start instruction input unit, the non-achievement notification signal may be outputted. Thus, the static state can be securely grasped after the start of measurement.

(7) The start instruction input unit may be provided on the side of a sensor unit where the inertial sensor is loaded. The sensor unit is attached to the sporting gear or the subject. The subject can easily cause the start instruction input unit to output the trigger signal.

(8) The calculation unit may detect an amount of inertia in a swing movement with at least one of the sporting gear and the subject, using the output from the inertial sensor, and may report to the subject whether the swing movement is good or no good, based on the amount of inertia. The subject can learn whether his or her swing is good or no good, according to the amount of inertia. Thus, good improvement can be added to the form of a golf swing through trial and error.

### BRIEF DESCRIPTION OF THE DRAWINGS

The invention will be described with reference to the accompanying drawings, wherein like numbers reference like elements.

FIG. 1 is a conceptual view schematically showing the configuration of a golf swing analysis device according to one embodiment of the invention.

FIG. 2 is a conceptual view schematically showing the relation between a three-dimensional pendulum model, and a golfer and a golf club.

FIG. 3 is a conceptual view of the position of a club head used for the three-dimensional pendulum model.

FIG. 4 is a block diagram schematically showing the configuration of a calculation processing circuit according to the one embodiment.

FIG. 5 is a block diagram schematically showing the configuration of a shaft plane image data generation unit and a Hogan plane image data generation unit.

FIG. 6 is a conceptual view of the shaft plane and the Hogan plane.

FIG. 7 is a conceptual view showing a method for generating the shaft plane.

FIG. 8 is a conceptual view showing a method for generating the Hogan plane.

FIG. 9 is a conceptual view showing a method for generating the Hogan plane.

FIG. 10 is a block diagram schematically showing the configuration of a swing movement calculation unit.

FIG. 11 is a conceptual view schematically showing a specific example of an image according to a result of analysis.

### DESCRIPTION OF EXEMPLARY EMBODIMENTS

Hereinafter, an embodiment of the invention will be described with reference to the accompanying drawings. The following embodiment should not unduly limit the content of the invention described in the appended claims. Not all the configurations described in this embodiment are necessarily essential as elements of the invention.

### 1. Configuration of Golf Swing Analysis Device

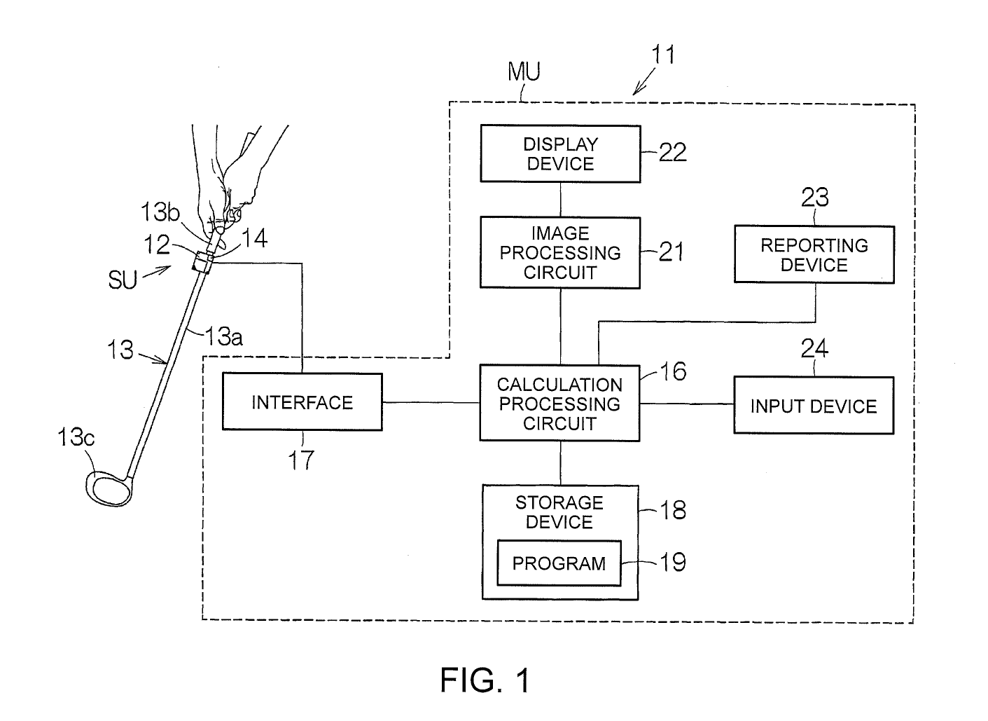

FIG. 1 schematically shows the configuration of a golf swing analysis device (motion analysis device) 11 according to one embodiment of the invention. The golf swing analysis device 11 has, for example, a sensor unit SU and a main body unit MU. An inertial sensor 12 is loaded in the sensor unit SU. An acceleration sensor and a gyro sensor are incorporated in the inertial sensor 12. The acceleration sensor can detect each one of accelerations generated in three axial directions that are orthogonal to each other. The gyro sensor can detect each one of angular velocities about each of the three orthogonal axes. The inertial sensors 12 outputs a detection signal. The detection signal specifies the amount of inertia. That is, based on the detection signal, the acceleration and angular velocity are specified for each axis.

The sensor unit SU is attached to a golf club (sporting gear) 13. The golf club 13 has a shaft 13a and a grip 13b. The grip 13b is held by the hands. The grip 13b is formed coaxially with the axis of the shaft 13a. A club head 13c is connected to a distal end of the shaft 13a. Preferably, the sensor unit SU is attached to the shaft 13a or the grip 13b of the golf club 13. The sensor unit SU may be fixed so that the sensor unit SU cannot move relative to the golf club 13. Here, when attaching the sensor unit SU, one of the detection axes of the inertial sensor 12 is aligned with the direction of the axis of the shaft 13a.

A switch (start instruction input unit) 14 is incorporated in the sensor unit SU. The switch 14 outputs a trigger signal to start measurement with the inertial sensor 12. As the switch 14 is operated, the inertial sensor 12 starts operating. After the operation is started, a detection signal is continuously outputted from the inertial sensor 12. At the same time, the trigger signal is outputted from the sensor unit SU as a start instruction signal. It is desired that the sensor unit SU is attached to a position where the subject can easily reach the switch 14 with his or her hand when gripping the grip 13b and holding the golf club 13 ready to swing.

A calculation processing circuit (calculation unit) 16 is loaded in the main body unit MU. The inertial sensor 12 and the switch 14 are connected to the calculation processing circuit 16. For this connection, a predetermined interface circuit 17 is connected to the calculation processing circuit 16. The interface circuit 17 may be wired to the inertial sensor 12 and the switch 14 or wirelessly connected to the inertial sensor 12 and the switch 14. The detection signal and the start instruction signal are inputted to the calculation processing circuit 16 from the sensor unit SU.

A storage device 18 is connected to the calculation processing circuit 16. In the storage device 18, for example, a golf swing analysis software program 19 and related data are stored. The calculation processing circuit 16 executes the golf swing analysis software program 19 to realize a golf swing analysis method. The storage device 18 includes a DRAM (dynamic random access memory), a large-capacity storage unit, a non-volatile memory or the like. For example, in the DRAM, the golf swing analysis software program 19 is temporarily held when carrying out the golf swing analysis method. In the large-capacity storage unit such as a hard disk drive (HDD) the golf swing analysis software program and data are saved. In the non-volatile memory, a relatively small-capacity program such as BIOS (basic input/output system) and data are stored.

An image processing circuit 21 is connected to the calculation processing circuit 16. The calculation processing circuit 16 sends predetermined image data to the image processing circuit 21. A display device 22 is connected to the image processing circuit 21. For this connection, a predetermined interface circuit (not shown) is connected to the image processing circuit 21. The image processing circuit 21 sends an image signal to the display device 22, according to the image data inputted thereto. An image specified by the image signal is displayed on the screen of the display device 22. As the display device 22, a liquid crystal display or another type of flat panel display is used. Here, the calculation processing circuit 16, the storage device 18 and the image processing circuit 21 may be provided, for example, as a computer device.

A reporting device 23 is connected to the calculation processing circuit 16. A static state notification signal and a non-achievement notification signal are sent to the reporting device 23 from the calculation processing circuit 16. Details of the static state notification signal and the non-achievement notification signal will be described later. In response to reception of the static state notification signal or the non-achievement notification signal, the reporting device 23 generates a physical change that is perceived by the subject with his or her five senses. As the physical change, a physical change that is unique to the static state notification signal, and a physical change that is different from the physical change unique to the static state notification signal and that is unique to the non-achievement notification signal are allocated. For example, the reporting device 23 can include a sound source circuit and a speaker. The speaker can output a sound that is auditorily perceived by the subject, according to an electrical signal supplied from the sound source circuit. The sound outputted when the static state notification signal is received and the sound outputted when the non-achievement notification signal is received may be different from each other. Alternatively, the reporting device 23 may be a device that is visually perceived by the subject, other than a display device such as a so-called display panel. Such a device may include, for example, a flashing light source such as a flash. In such a case, different flashing patterns may be set for the static state notification signal and for the non-achievement notification signal. Moreover, the reporting device 23 may have a vibration source. Vibration can be perceived by the subject as a bodily sensation. In such a case, different vibration patterns may set for the static state notification signal and for the non-achievement notification signal.

An input device 24 is connected to the calculation processing circuit 16. The input device 24 has at least alphabetical keys and ten keys. Letter information and numerical value information are inputted to the calculation processing circuit 16 from the input device 24. The input device 24 may include, for example, a keyboard. The combination of the computer device with the keyboard may be replaced, for example, with a smartphone, mobile phone, or tablet PC (personal computer). In such a case, a vibrator installed in the smartphone or the like may be used as the vibration source.

### 2. Three-Dimensional Pendulum Model

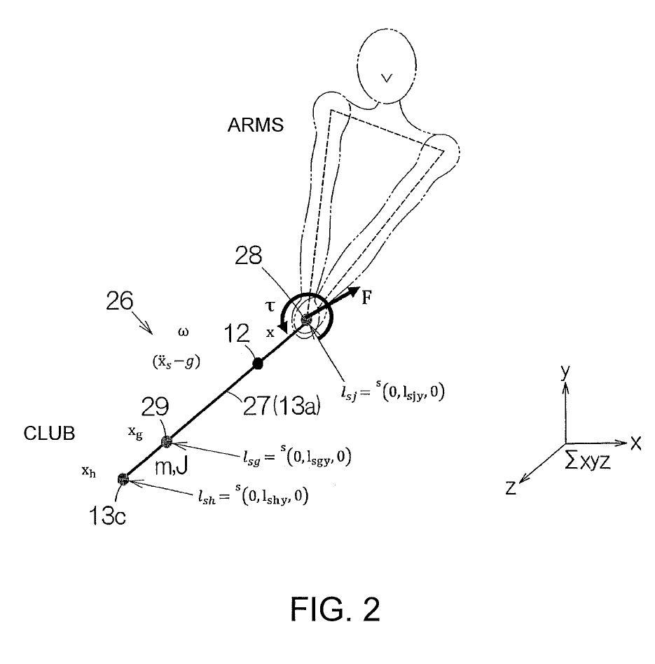

The calculation processing circuit 16 prescribes an imaginary space. The imaginary space is formed as a three-dimensional space. As shown in FIG. 2, the three-dimensional space has an absolute reference coordinate system Σ_{xyz}. In the three-dimensional space, a three-dimensional pendulum model 26 is constructed in accordance with the absolute reference coordinate system Σ_{xyz}. A bar 27 in the three-dimensional pendulum model 26 is point-constrained at a support 28 (coordinate x). The bar 27 acts as a pendulum three-dimensionally about the support 28. The position of the support 28 can be moved. Here, according to the absolute reference coordinate system Σ_{xyz} the position of the center of gravity 29 of the bar 27 is specified by a coordinate x_{g} and the position of the club head 13c is specified by a coordinate xₕ.

The three-dimensional pendulum model 26 is equivalent to a modeling of the golf club 13 at the time of a swing. The pendulum bar 27 projects the shaft 13a of the golf club 13. The support 28 of the bar 27 projects the grip 13b. The inertial sensor 12 is fixed on the bar 27. According to the absolute reference coordinate system Σ_{xyz}, the position of the inertial sensor 12 is specified by a coordinate xₛ. The inertial sensor 12 outputs an acceleration signal and an angular velocity signal. The acceleration signal specifies an acceleration minus the influence of gravitational acceleration g, that is, (\ddot{X}ₛ−g). The angular velocity signal specifies angular velocities ω₁, ω₂.

The calculation processing circuit 16 similarly fixes a local coordinate system Σₛ on the inertial sensor 12. The origin of the local coordinate system Σₛ is set at the origin of the detection axis of the inertial sensor 12. The y-axis of the local coordinate system Σₛ coincides with the axis of the shaft 13a. The x-axis of the local coordinate system Σₛ coincides with the ball hitting direction that is specified by the direction of the face. Therefore, according to the local coordinate system Σₛ, the position lₛⱼ of the support is specified by (0, l_{sjy}, 0). Similarly, on this local coordinate system Σₛ, the position l_{sg} of the center of gravity 29 is specified by (0, l_{sgy}, 0), and the position lₛₕ of the club head 13c is specified by (0, l_{shy}, 0).

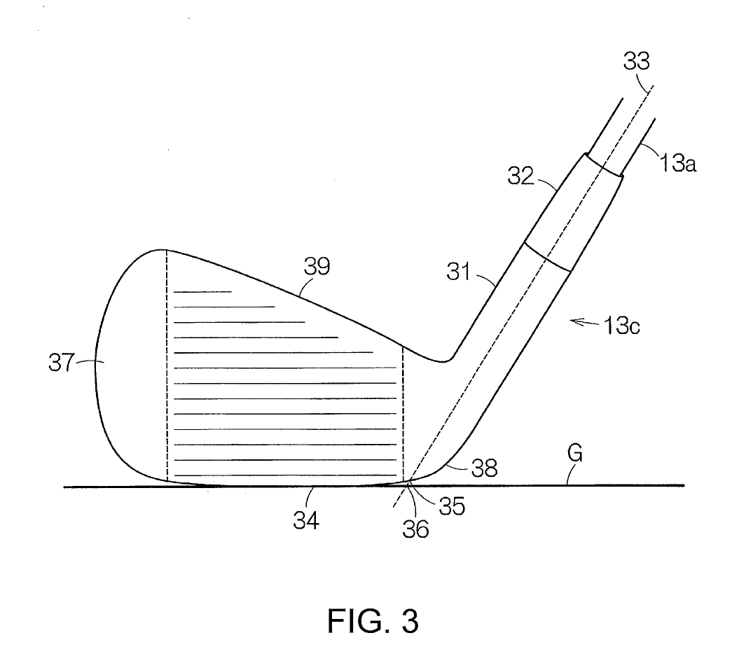

As shown in FIG. 3, at the club head 13c, the shaft 13a is inserted in a hosel 31. A ferrule 32 is arranged at the boundary between the hosel 31 and the shaft 13a. The axis of the hosel 31 and the ferrule 32 is arranged coaxially with an axis 33 of the shaft 13a. The position lₛₕ of the club head 13c may be specified, for example, by a point of intersection 35 between an extension line of the axis (axial line) 33 of the shaft 13a and a sole 34 of the club head 13c. Alternatively, the position lₛₕ of the club head 13c may be specified by a point of intersection 36 between the extension line of the axis 33 of the shaft 13a and ground G when the sole 34 of the club head 13c flatly contacts the ground G. Also, unless there is any problem with image forming as described later, the position lₛₕ of the club head 13c may be set by a toe 37 and a heal 38 of the club head 13c, another part on the sole 34, a crown 39, and peripheries thereof. However, it is desirable that the position lₛₕ of the club head 13c is set on the axis 33 of the shaft 13a (or on the extension line thereof).

### 3. Configuration of Calculation Processing Circuit

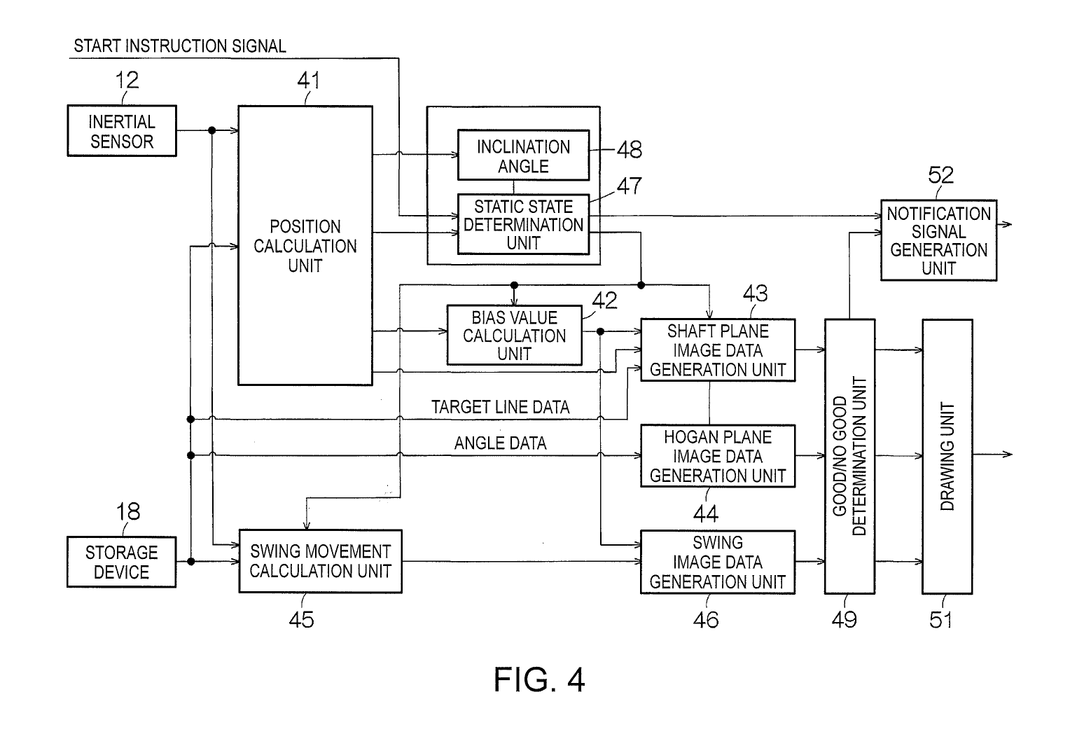

FIG. 4 schematically shows the configuration of the calculation processing circuit 16 according to the one embodiment. The calculation processing circuit 16 has a position calculation unit 41. The acceleration signal and the angular velocity signal are inputted to the position calculation unit 41 from the inertial sensor 12. The position calculation unit 41 calculates the coordinates of the club head 13c and the coordinates of the grip end according to the absolute reference coordinate system Σ_{xyz} in the imaginary three-dimensional space, based on the acceleration and angular velocity. In this calculation, the position calculation unit 41 acquires various numerical value data including club head data and grip end data from the storage device 18. The club head data specifies the position lₛₕ of the club head 13c, for example, according to the local coordinate system Σₛ of the inertial sensor 12. The grip end data specifies the position of the grip end, for example, according to the local coordinate system Σₛ of the inertial sensor 12. Here, the position of the grip end may be the position lₛⱼ of the support 28. Also, in specifying the position of the club head 13c and the position of the grip end, the length of the golf club 13 may be specified and the position of the inertial sensor 12 may be specified on the golf club 13.

The calculation processing circuit 16 has a bias value calculation unit 42. Here, the bias value calculation unit 42 is connected to the position calculation unit 41. The bias value calculation unit 42 calculates the bias value of the inertial sensor 12, based on the output from the position calculation unit 41. The bias value can be specified based on the detection signal outputted from the inertial sensor 12 in the static state. The bias value calculation unit 42 finds a bias estimate value that is a function of time, based on the information of the position of the club head 13c and the position of the grip end acquired during a predetermined period. To derive the bias estimate value, data is sampled at an arbitrary time interval and linearly approximated on a two-dimensional plane including a time axis. Here, the bias is a general term for an error including zero-bias in the initial state where angular velocity is zero and random drifts due to external factors such as power supply fluctuations and temperature fluctuations. The bias value calculation unit 42 may be connected directly to the inertial sensor 12 and may calculate the bias value of the inertial sensor 12, based on the output from the inertial sensor 12.

The calculation processing circuit 16 has a shaft plane image data generation unit 43. The shaft plane image data generation unit 43 is connected to the position calculation unit 41. The shaft plane image data generation unit 43 generates three-dimensional image data to visualize a first imaginary plane, that is, the shaft plane in three dimensions, based on the coordinates of the grip end. To generate the three-dimensional image data, the shaft plane image data generation unit 43 refers target line data and the bias estimate value. The target line data represents a line segment which specifies the ball hitting direction on the absolute reference coordinate system Σ_{xyz}, that is, a target line. The target line data may be stored in the storage device 18 in advance. The coordinates of the grip end are corrected, based on the bias estimate value.

The calculation processing circuit 16 has a Hogan plane image data generation unit 44. The Hogan plane image data generation unit 44 is connected to the shaft plane image data generation unit 43. The Hogan plane image data generation unit 44 generates three-dimensional image data to visualize a second imaginary plane, that is, the Hogan plane in three dimensions, based on the first imaginary plane, that is, the shaft plane generated by the shaft plane image data generation unit 43. To generate the three-dimensional image data, the Hogan plane image data generation unit 44 refers to angle data. The angle data may be stored in the storage device 18 in advance.

The calculation processing circuit 16 has a swing movement calculation unit 45. The acceleration signal and the angular velocity signal are inputted to the swing movement calculation unit 45 from the inertial sensor 12. The swing movement calculation unit 45 calculates the movement trajectory of the bar 27 in the three-dimensional pendulum model 26 according to the absolute reference coordinate system Σ_{xyz} in the imaginary three-dimensional space, based on the acceleration and angular velocity. Such a movement trajectory is specified based on the position of the support 28 and the position of the club head 13c. In specifying the movement trajectory, the positions of the support 28 and the club head 13c are specified, for example, at a predetermined time interval along the time axis.

The calculation processing circuit 16 has a swing image data generation unit 46. The swing image data generation unit 46 is connected to the swing movement calculation unit 45. The swing image data generation unit 46 generates three-dimensional image data to visualize the movement trajectory of the bar 27 in three dimensions, based on the position of the support 28 and the position of the club head 13c along the time axis. In generating the three-dimensional image data, the swing image data generation unit 46 corrects the position of the support 28 and the position of the club head 13c, based on the bias estimate value.

The calculation processing circuit 16 has a static state determination unit 47. The static state determination unit 47 is connected to the position calculation unit 41. The static state determination unit 47 determines the static state of the golf club 13, based on the output from the inertial sensor 12. If the output from the inertial sensor 12 (in this example, the output from the position calculation position 41) falls within a first range, the static state determination unit 47 determines the static state of the golf club 13. As the first range, a threshold value that can eliminate the influence of a detection signal indicating micro-vibration such as body motion may be set. If the static state is confirmed over a predetermined period, the static state determination unit 47 outputs a selection signal representing a static state notification signal. The selection signal is sent to the bias value calculation unit 42, the shaft plane image data generation unit 43 and the swing movement calculation unit 45. The bias value calculation unit 42 calculates the bias value of the inertial sensor 12 while the golf club 13 is in the static state, in response to reception of the selection signal. The shaft plane image data generation unit 43 specifies the shaft plane while the golf club 13 is in the static state, in response to reception of the selection signal. The swing movement calculation unit 45 starts calculating the movement trajectory in response to reception of the selection signal.

The calculation processing circuit 16 has an inclination angle calculation unit 48. The inclination angle calculation unit 48 is connected to the static state determination unit 47. The inclination angle calculation unit 48 calculates the angle of inclination and posture of the golf club 13, based on the coordinates of the grip end and the coordinates of the club head 13c. The static state determination unit 47 determines the posture of the golf club 13 at the address, based on the calculated angle of inclination. Whether the inclination of a line segment in the direction in which the shaft 13a extends falls within a second range or not, is determined. The static state determination unit 47 starts determining the static state of the golf club 13 after the posture of the golf club 13 at the address is established.

A start instruction signal is supplied to the static state determination unit 47 from the switch 14. On receiving the start instruction signal, the static state determination unit 47 starts measuring time. If the establishment of the static state is not detected over a predetermined period (within a first period) as a result of the time measurement, the static state determination unit 47 outputs a selection signal representing a non-achievement notification signal.

The calculation processing circuit 16 has a good/no good determination unit 49. The good/no good determination unit 49 is connected to the shaft plane image data generation unit 43, the Hogan plane image data generation unit 44 and the swing image data generation unit 46. The good/no good determination unit 49 determines whether a swing movement is good or no good, based on the shaft plane, the Hogan plane and the trajectory of the golf club 13. For example, in the case where a straight ball is intended, if the trajectory of the golf club 13 in a swing falls between the shaft plane and the Hogan plane, the good/no good determination unit 49 determines that the swing movement is “good”. In this case, if the swing is inside-out or outside-in, the good/no good determination unit determines that the swing movement is “no good”. In the case where a draw ball is intended, if an inside-out trajectory with respect to the shaft plane and the Hogan plane is drawn, the good/no good determination unit 49 determines that the swing movement is “good”. Otherwise, the good/no good determination unit 49 determines that the swing movement is “no good”. In the case where a fade ball is intended, if an outside-in trajectory with respect to the shaft plane and the Hogan plane is drawn, the good/no good determination unit 49 determines that the swing movement is “good”. Otherwise, the good/no good determination unit 49 determines that the swing movement is “no good”. The intension of a straight ball, draw ball or fade ball may be inputted, for example, by the subject operating the input device 24. If the good/no good determination unit 49 determines that the swing movement is “good”, the good/no good determination unit 49 outputs a determination signal of “good”. If the good/no good determination unit 49 determines that the swing movement is “no good”, the good/no good determination unit 49 outputs a determination signal of “no good”.

The calculation processing circuit 16 has a drawing unit 51. The drawing unit 51 is connected to the good/no good determination unit 49. The three-dimensional image data from the shaft plane image data generation unit 43, the three-dimensional image data from the Hogan plane image data generation unit 44 and the three-dimensional image data from the swing image data generation unit 46 are supplied to the drawing unit 51 from the good/no good determination unit 49. Based on these three-dimensional image data, the drawing unit 51 generates three-dimensional image data to visualize the movement trajectory of the golf club 13 superimposed on the shaft plane and the Hogan plane in three dimensions.

The calculation processing circuit 16 has a notification signal generation unit 52. The selection signal is supplied to the notification signal generation unit 52 from the static state determination unit 47. The notification signal generation unit 52 outputs the static state notification signal in response to reception of the selection signal representing the static state notification signal, and outputs the non-achievement notification signal in response to reception of the selection signal representing the non-achievement notification signal. Similarly, the determination signal is supplied to the notification signal generation unit 52 from the good/no good determination unit 49. The notification signal generation unit 52 outputs the static state notification signal in response to reception of the determination signal representing “good”, and outputs the non-achievement notification signal in response to reception of the determination signal representing “no good”.

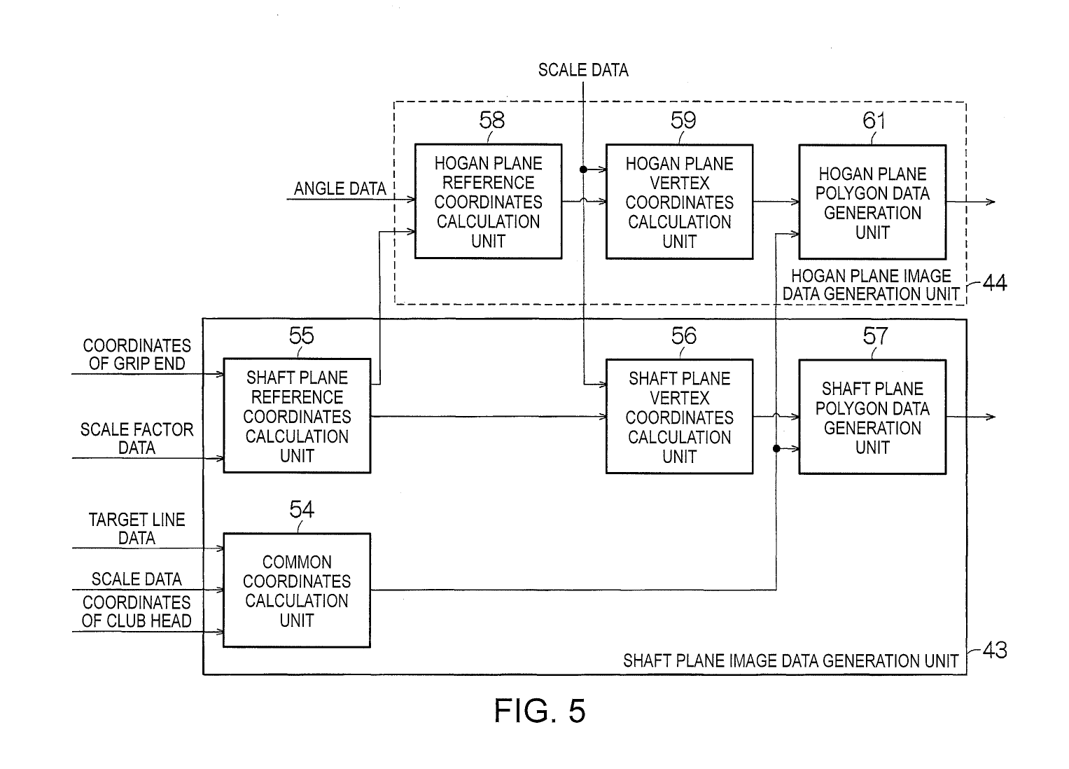

As shown in FIG. 5, the shaft plane image data generation unit 43 has a common coordinates calculation unit 54, a shaft plane reference coordinates calculation unit 55, a shaft plane vertex coordinates calculation unit 56, and a shaft plane polygon data generation unit 57. The common coordinates calculation unit 54 calculates the coordinates of two vertices of the shaft plane, based on the target line data. Details of this calculation will be described later. The shaft plane reference coordinates calculation unit 55 calculates a reference position of the shaft plane on the extension line of the axis 33 of the shaft 13a, based on the coordinates of the grip end. The shaft plane vertex coordinates calculation unit 56 is connected to the shaft plane reference coordinates calculation unit 55. The shaft plane vertex coordinates calculation unit 56 calculates the coordinates of two vertices of the shaft plane, based on the calculated reference position of the shaft plane. The shaft plane polygon data generation unit 57 is connected to the shaft plane vertex coordinates calculation unit 56 and the common coordinates calculation unit 54. The shaft plane polygon data generation unit 57 generates polygon data of the shaft plane, based on the coordinates of the four vertices in total that are calculated. The polygon data is equivalent to the three-dimensional image data to visualize the shaft plane in three dimensions.

Similarly, the Hogan plane image data generation unit 44 has a Hogan plane reference coordinates calculation unit 58, a Hogan plane vertex coordinates calculation unit 59, and a Hogan plane polygon data generation unit 61. The Hogan plane reference coordinates calculation unit 58 calculates a reference position of the Hogan plane, based on the reference position of the shaft plane. In this calculation, the Hogan plane reference coordinates calculation unit 58 refers to angle data. The Hogan plane vertex coordinates calculation unit 59 is connected to the Hogan plane reference coordinates calculation unit 58. The Hogan plane vertex coordinates calculation unit 59 calculates the coordinates of two vertices of the Hogan plane, based on the calculated reference position. The Hogan plane polygon data generation unit 61 is connected to the Hogan plane vertex coordinates calculation unit 59 and the common coordinates calculation unit 54. The Hogan plane polygon data generation unit 61 generates polygon data of the Hogan plane, based on the coordinates of the four points in total that are calculated. The polygon data is equivalent to the three-dimensional image data to visualize the Hogan plane in three dimensions.

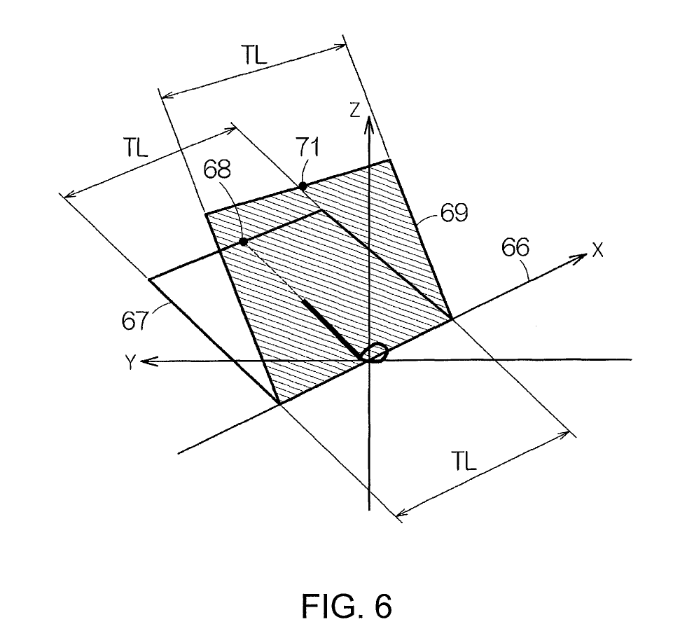

The shaft plane image data generation unit 43 and the Hogan plane image data generation unit 44 will be described in detail with reference to FIGS. 6 to 8. The common coordinates calculation unit 54 refers to the coordinates of the club head 13c and scale data, when calculating the coordinates of the vertices. As clear from FIG. 6, the scale data specifies a numerical value TL indicating the size of a shaft plane 67 on a target line 66. The numerical value TL is set as such a size that an entire swing movement falls within the shaft plane 67 when the swing movement is projected on the shaft plane 67. When calculating the coordinates of the vertices, the common coordinates calculation unit 54 can align the position of the club head 13c with the target line 66, by comparing the coordinates of the club head 13c with the target line 66.

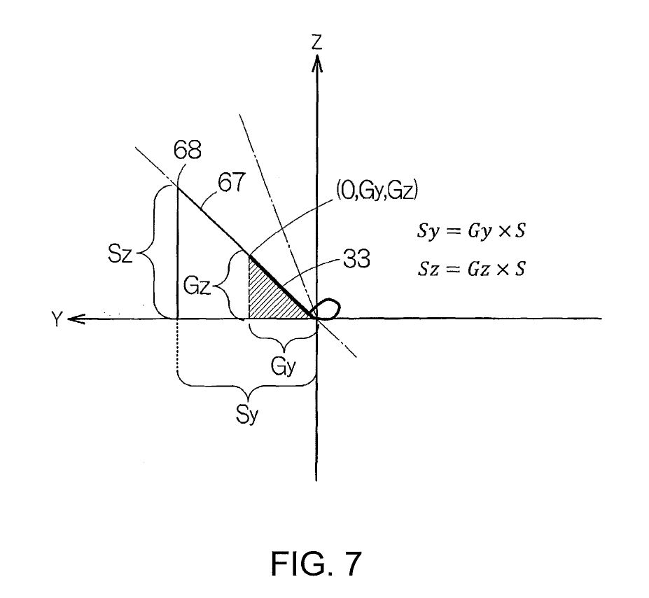

The shaft plane reference coordinates calculation unit 55 refers to scale factor data when calculating the reference position. As shown in FIG. 7, the scale factor data specifies a magnification rate S of the axis 33 of the shaft 13a. In accordance with the magnification rate S, an extension line of the axis 33 of the shaft 13a is specified beyond the grip end (0, Gy, Gz). At the end of the extension line, a reference position 68 (0, Sy, Sz) of the shaft plane 67 is specified. The magnification rate S of the axis 33 is set at such a numerical value that an entire swing movement falls within the shaft plane 67 when the swing movement is projected on the shaft plane 67.

The shaft plane vertex coordinates calculation unit 56 refers to the scale data when calculating the coordinates of the vertices. As clear from FIG. 6, a line segment with a length TL passing through the reference position 68 of the shaft plane 67 is specified. The line segment is drawn parallel to the target line. The coordinates S1, S2 of the vertices are provided at both ends of this line segment.

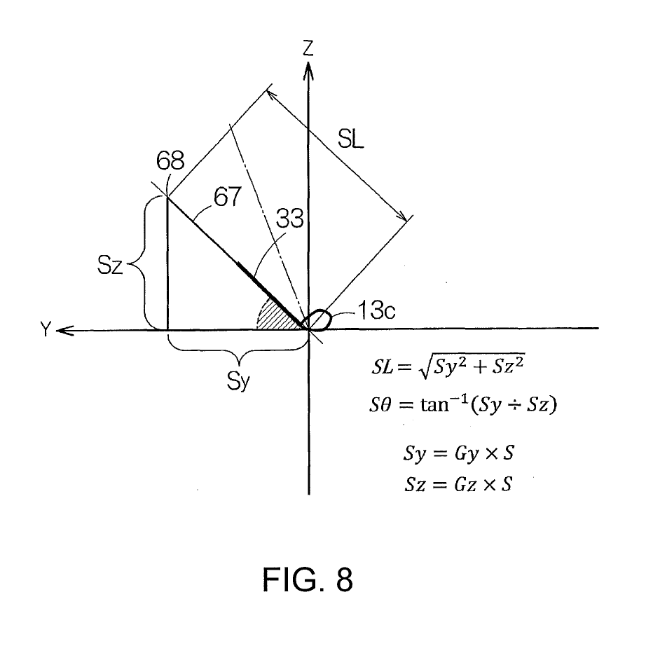

As shown in FIG. 8, when calculating the reference position (0, Hy, Hz) of the Hogan plane, the length SL and the angle Sθ of the shaft plane 67 are sent to the Hogan plane reference coordinates calculation unit 58. The length SL and the angle Sθ can be calculated based on the coordinates (0, Sy, Sz) of the reference position 68 of the shaft plane 67. These may be calculated by the shaft plane reference coordinates calculation unit 55 or by the Hogan plane reference coordinates calculation unit 58.

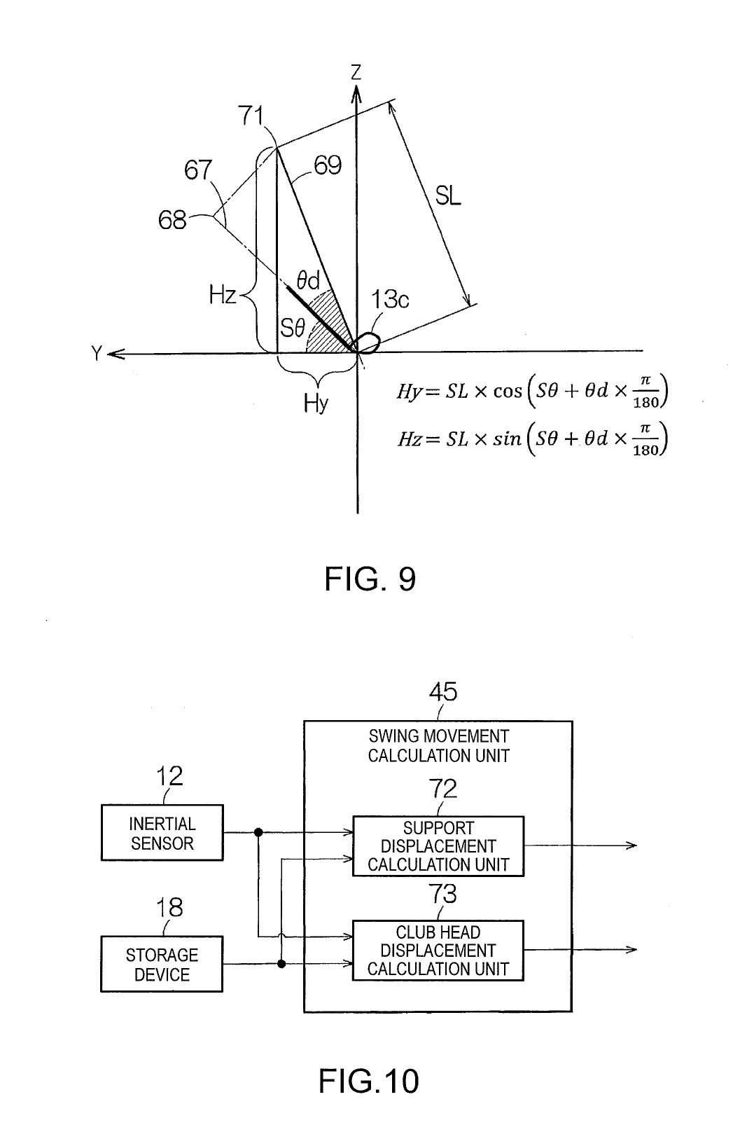

As shown in FIG. 9, the Hogan plane reference coordinates calculation unit 58 rotates the reference position 68 of the shaft plane 67 about the target line 66. The angle θd of this rotation is specified by the angle data. Based on this rotation, a reference position 71 (0, Hy, Hz) of the Hogan plane 69 is acquired. Thus, according to the golf swing analysis device 11, analysis of a golf swing can be realized with a single inertial sensor (inertial sensor 12).

As shown in FIG. 10, the swing movement calculation unit 45 has a support displacement calculation unit 72 and a club head displacement calculation unit 73. The acceleration signal and the angular velocity signal are inputted to the support displacement calculation unit 72 from the inertial sensor 12. Based on the acceleration and the angular velocity, the support displacement calculation unit 72 calculates the displacement of the support 28 according to the time axis. For example, if the displacement of the inertial sensor 12 and the posture of the bar 27 are specified, the displacement of the support 28 can be specified. The displacement of the inertial sensor 12 can be calculated based on the acceleration from the inertial sensor 12. The posture of the bar 27 can be calculated based on the angular velocity from the inertial sensor 12. The coordinates of the position of the support 28 are transformed from the local coordinate system Σₛ of the inertial sensor 12 to the absolute reference coordinate system Σ_{xyz}. In this coordinate transformation, a transformation matrix can be supplied from the storage device 18.

The acceleration signal and the angular velocity signal are inputted to the club head displacement calculation unit 73 from the inertial sensor 12. Based on the acceleration and the angular velocity, the club head displacement calculation unit 73 calculates the displacement of the club head 13c according to the time axis. For example, if the displacement of the inertial sensor 12 and the posture of the bar 27 are specified, the displacement of the club head 13c can be specified within the local coordinate system Σₛ of the inertial sensor 12. The displacement of the inertial sensor 12 can be calculated based on the acceleration from the inertial sensor 12. The posture of the bar 27 can be calculated based on the angular velocity from the inertial sensor 12. The coordinates of the position of the club head 13c are transformed from the local coordinate system Σₛ to the absolute reference coordinate system Σ_{xyz}. In such coordinate transformation, the club head displacement calculation unit 73 may be notified of the position of the support 28 from the support displacement calculation unit 72.

### 4. Operation of Golf Swing Analysis Device

The operation of the golf swing analysis device 11 will be described briefly. First, a golfer's golf swing is measured. Before the measurement, necessary information is inputted to the calculation processing circuit 16 from the input device 24. Here, according to the three-dimensional pendulum model 26, input of the position lₛⱼ of the support 28 according to the local coordinate system Σₛ and a rotation matrix Ro of the initial posture of the inertial sensor 12 is prompted. The inputted information is managed, for example, under a specific identifier. The identifier may identify a specific golfer.

Before the measurement, the inertial sensor 12 is attached to the shaft 13a of the golf club 13. The inertial sensor 12 is fixed so that the inertial sensor 12 cannot be displaced relative to the golf club 13. Here, one of the detection axes of the inertial sensor 12 is aligned with the axis of the shaft 13a. Another one of the detection axes of the inertial sensor 12 is aligned with the ball hitting direction specified by the direction of the face.

The measurement by the inertial sensor 12 is started before the execution of a golf swing. In response to an operation of the switch 14, a trigger signal is outputted from the switch 14. The inertial sensor 12 starts operating in response to the output of the trigger signal. At the start of the operation, the inertial sensor 12 is set in a predetermined position and posture. The position and posture correspond to the position and posture specified by the rotation matrix R⁰ of the initial posture. The inertial sensor 12 continuously measures acceleration and angular velocity at a specific sampling interval. The sampling interval prescribes the resolution of the measurement. A detection signal from the inertial sensor 12 is sent in real time to the calculation processing circuit 16. The calculation processing circuit 16 receives a signal specifying the output from the inertial sensor 12.

A golf swing starts with the address, goes through the backswing, downswing and impact, then goes on to the follow-through and reaches the finish. At the address, the posture of the subject is static. The inclination angle calculation unit 48 of the calculation processing circuit 16 calculates the angle of inclination of the golf club 13. If the angle of inclination falls within a predetermined range of inclination angle (second range), the static state determination unit 47 of the calculation processing circuit 16 determines the static state of the golf club 13. If the output from the inertial sensor 12 falls within the first range, the static state determination unit 47 grasps the static state. Thus, in response to the static state of the golf club 13, a static state notification signal is outputted from the notification signal generation unit 52. The static state notification signal is sent to the reporting device 23. The reporting device 23 generates a physical change such as sound, light or vibration. As the static state is thus secured, preparation for measurement is complete in the golf swing analysis device 11, as described later.

As the subject is notified of the completion of the preparation for measurement, the subject can start a swing movement. The swing movement shifts from the address to the backswing, goes through the downswing and impact, then goes on to the follow-through, and reaches the finish. The golf club 13 is swung. When swung, the golf club 13 changes its posture according to the time axis. The inertial sensor 12 outputs a detection signal in accordance with the posture of the golf club 13. The swing movement calculation unit 45 starts calculating the movement trajectory of the golf club 13. The swing movement calculation unit 45 can securely follow the movement of the golf club 13 over the entire swing. The golf swing analysis device 11 can securely start measurement at proper timing even when the subject is by himself or herself. Moreover, redundant analysis can be avoided before the swing is started.

When determining the static state, the static state determination unit 47 determines the posture of the golf club 13. The posture of the golf club 13 at the address is specified in accordance with the range of inclination angle. As the inclination of the axis 33 of the golf club 13 is thus specified, the static state corresponding to the start of measurement and the static state not corresponding to the start of measurement can be clearly distinguished. In other words, the static state at the address can be distinguished from the static state at the other timings. As a result, measurement can be prevented from being started in the static state that is not at the address. Proper timing can be securely specified.

Meanwhile, if the static state is not detected within a predetermined period after the start instruction signal is received, the static state determination unit 47 outputs a selection signal representing the non-achievement notification signal. The non-achievement of the static state is reported by the non-achievement notification signal. The non-achievement notification signal is sent to the reporting device 23. The reporting device 23 generates a physical change such as sound, light or vibration. In response to this physical change, the subject is prompted to establish the static state. Thus, the subject can securely establish the static state.

In response to the establishment of the static state, the selection signal is sent to the bias value calculation unit 42 from the static state determination unit 47. In response to reception of the selection signal, the bias value calculation unit 42 calculates a bias estimate value of the inertial sensor 12. Based on the bias estimate value, the output value from the inertial sensor 12 is corrected. At this point, in calculating the bias estimate value, the inertial sensor 12 is required to have the static state of the golf club 13. Since the selection signal is outputted in accordance with the establishment of the static state, the calculation of the bias estimate value can be completed securely. As the bias value is thus calculated in advance, the swing movement calculation unit 45 can specify the trajectory of the golf club 13 in real time. The movement of the subject can be analyzed in real time.

In the address posture, the subject reproduces the posture at the moment of impact. As a result, the posture at the moment of impact is extracted from a series of movements called “golf swing”. At this point, the golf club 13 is held in a static posture. The posture of the subject's upper limbs is fixed. A detection signal at the address is outputted from the inertial sensor 12.

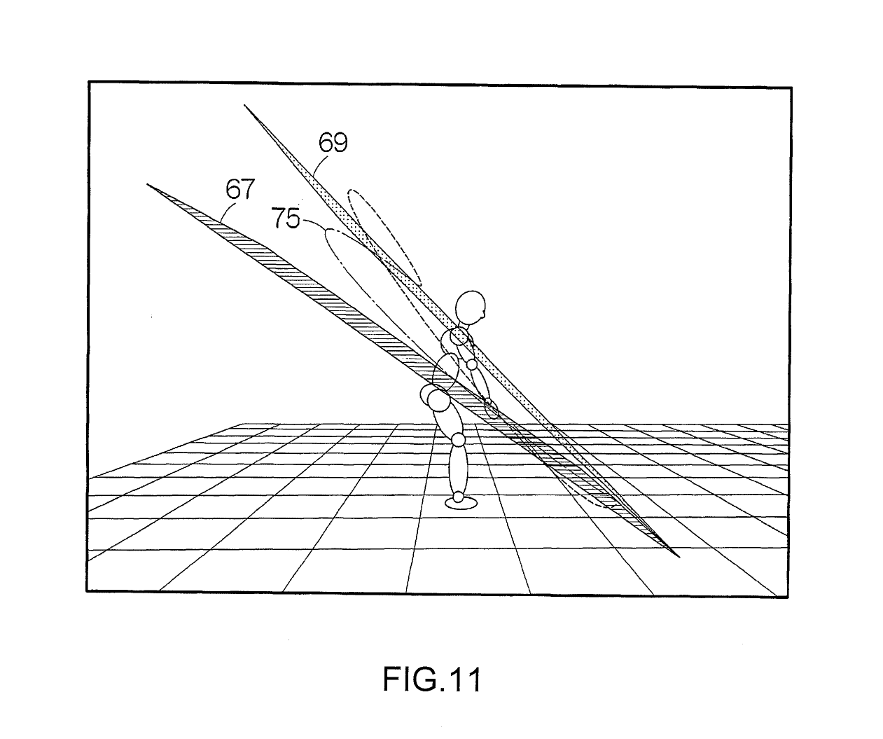

The shaft plane image data generation unit 43 of the calculation processing circuit 16 calculates the shaft plane based on the detection signal at the address. The Hogan plane image data generation unit 44 of the calculation processing circuit 16 calculates the Hogan plane based on the detection signal at the address. The swing image data generation unit 46 of the calculation processing circuit 16 calculates the movement trajectory of the golf club 13 based on the detection signal at the time of the swing movement. As shown in FIG. 11, in accordance with the calculation of the shaft plane and the Hogan plane and the calculation of the trajectory of the golf club 13, the drawing unit 51 of the calculation processing circuit 16 generates three-dimensional image data to visualize the trajectory 75 of the golf club 13 in three dimensions superimposed on the shaft plane 67 and the Hogan plane 69. The three-dimensional image data is supplied to the image processing circuit 21. As a result, a desired image is displayed on the screen of the display device 22.

Here, the target line 66 can be calculated based on the detection signal at the address. In this calculation, the x-axis of the inertial sensor 12 is aligned in advance with the ball hitting direction specified by the direction of the face. Therefore, when the coordinates of the club head 13c are specified at the address, the target line 66 can be specified based on the parallel movement of the x-axis of the inertial sensor 12. However, the target line 66 may be specified by other methods.

The inertial sensor 12 outputs a detection signal in accordance with the posture of the golf club 13 at the address. In response to the detection signal, the shaft plane 67 and the Hogan plane 69 are specified. The shaft plane 67 can draw an imaginary trajectory of the golf club 13 swung in a golf swing. The trajectory of the golf club 13 in the golf swing is observed in comparison with the imaginary trajectory. Similarly, the trajectory of the golf club 13 in the swing is observed in comparison with the Hogan plane 69. Based on the trajectory of the golf club 13, the subject's swing movement can be analyzed. Thus, a clear indicator can be provided with respect to the motion called “golf swing”.

The good/no good determination unit 49 of the calculation processing circuit 16 determines whether the swing movement is good or no good, based on the shaft plane, the Hogan plane and the trajectory of the golf club 13. If the good/no good determination unit 49 determines the swing movement is “good”, the good/no good determination unit 49 outputs a determination signal of “good”. In response to the output of the determination signal, a static state notification signal is outputted from the notification signal generation unit 52. The static state notification signal is sent to the reporting device 23. As in the above description, the reporting device 23 generates a physical change such as sound, light or vibration in response to reception of the static state notification signal. If the good/no good determination unit 49 determines that the swing movement is “no good”, the good/no good determination unit 49 outputs a determination signal of “no good”. In response to the output of the determination signal, a non-achievement notification signal is outputted. The non-achievement notification signal is sent to the reporting device 23. As in the above description, the reporting device 23 generates a physical change such as sound, light or vibration in response to reception of the non-achievement notification signal. The subject thus can learn whether his or her golf swing is good or no good, according to the physical change. Thus, good improvement can be added to the form of a golf swing through trial and error.

In the above embodiment, the individual function blocks of the calculation processing circuit 16 are realized in accordance with the execution of the golf swing analysis software program 19. However, the individual function blocks may be realized by hardware without depending on software processing. Moreover, the golf swing analysis device 11 may also be applied to swing analysis of other sporting gears held and swung by the hand (for example, a tennis racket or table tennis racket). In such cases, an imaginary plane equivalent to the shaft plane may be used in swing analysis.

While the embodiment is described above in detail, a person skilled in the art can readily understand that various modifications can be made without substantially departing from the new matters and advantageous effects of the invention. Therefore, all such modifications are included in the scope of the invention. For example, in the specification and drawings, a term described along with a different term with a broader meaning or the same meaning at least once can be replaced with the different term in any part of the specification and drawings. Also, the configurations and operations of the inertial sensor 12, the golf club 13, the grip 13b, the club head 13c, the calculation processing circuit 16 and the like are not limited to those described in the embodiment, and various modifications can be made.

The entire disclosure of Japanese Patent Application No. 2013-141720, filed Jul. 5, 2013 is expressly incorporated by reference herein.

What is claimed is:

1. A motion analysis device comprising: a calculation unit which determines a static state of at least one of a sporting gear and a subject, using an output from an inertial sensor, and outputs a static state notification signal according to the static state.

2. The motion analysis device according to claim 1, wherein, when determining the static state, the calculation unit determines whether the output from the inertial sensor falls within a first range or not.

3. The motion analysis device according to claim 1, wherein, when determining the static state, the calculation unit determines whether an inclination of a line segment in a direction in which a shaft portion of the sporting gear extends falls within a second range or not, using the output from the inertial sensor.

4. The motion analysis device according to claim 3, wherein the output from the inertial sensor includes an output from an acceleration sensor, and
the inclination of the line segment in the direction in which the shaft portion of the sporting gear extends with respect to a direction of gravity is calculated, using the output from the acceleration sensor.

5. The motion analysis device according to claim 1, wherein the calculation unit outputs a non-achievement notification signal if the static state is not detected within a first period.

6. The motion analysis device according to claim 5, further comprising a start instruction input unit which outputs a trigger signal to start measurement with the inertial sensor,
wherein if the static state is not detected within the first period after the trigger signal is outputted from the start instruction input unit, the non-achievement notification signal is outputted.

7. The motion analysis device according to claim 6, wherein the start instruction input unit is provided on the side of a sensor unit where the inertial sensor is loaded.

8. The motion analysis device according to claim 1, wherein the calculation unit detects an amount of inertia in a swing movement with at least one of the sporting gear and the subject, using the output from the inertial sensor, and reports to the subject whether the swing movement is good or no good, based on the amount of inertia.
